(19) United States
(12) Patent Application Publication
(10) Pub. No.: US 2005/0000905 A1
(43) Pub. Date: Jan. 6, 2005

(54) Multi-stage photo-catalytic oxidation fluid treatment system

(75) Inventor: William M. Fields, Englewood, CO (US)

Correspondence Address: PATTON BOGGS, 1660 LINCOLN ST, SUITE 2050, DENVER, CO, 80264, US

(73) Assignee: Universal Water Technologies, LLC, Centennial, CO (US)

(21) Appl. No.: 10/874,489

(22) Filed: Jun. 22, 2004

Related U.S. Application Data
(62) Division of application No. 10/217,281, filed on Aug. 12, 2002.

(51) Int. Cl. C02F 1/463

(52) U.S. Cl. 210/702; 210/748

(57) ABSTRACT

The present multi-stage photo-catalytic oxidation fluid treatment system that uses a plurality of modules to implement an efficient, scalable and cost effective fluid treatment process to remove contaminants from a fluid. The multi-stage photo-catalytic oxidation fluid treatment system relies on mechanical and electronic elements, instead of chemicals, to treat the fluid that is input to the system and provide enhanced treatment of the contaminated fluid. The use of ozone and ions causes reactions with the contaminants that are contained in the fluid to purge the contaminants from the fluid or convert the contaminants to a form where they can be removed from the fluid or are rendered harmless.

### FIELD OF THE INVENTION

This invention relates to fluid treatment systems and to a multi-stage fluid treatment system that uses ionization and ozonizer subsystems to purify a contaminated fluid.

### Problem

It is a problem in the field of air and water treatment systems to effectively remove contaminants of varying characteristics from the fluid that is input to the system. The contaminants can be in the form of particulates, suspensions, solutions, mixtures, and can be of the class of contaminants that include: gases, biological, chemical, and the like.

In the field of water treatment systems, the pollutants can be categorized into the groups of: particulates, dissolved minerals, chemicals, microbiological and the like. Existing water treatment systems typically use dangerous chemicals, such as the potassium permanganate, typically used in green sand filtration, and/or the addition of reactive but dangerous chemicals, such as chlorine, to treat the water to kill the micro-bacterial contaminants. In addition to reliance on dangerous chemicals, these systems do not address the contaminants of dissolved minerals. These existing water treatment systems require skilled crafts-persons to operate and maintain and are expensive to implement. Therefore, such systems are typically reserved for municipal applications where the volume of water processed can justify the cost of operation and maintenance.

Thus, there is presently no effective treatment system for the removal of contaminants from either water or air and the application of existing treatment technologies to small systems applications renders the cost of even rudimentary treatment prohibitive. Thus, there is a need for an effective, inexpensive, scalable, and easily maintained fluid treatment system that can remove contaminants from fluids.

### Solution

The above-described problems are solved and a technical advance achieved by the present multi-stage photo-catalytic oxidation fluid treatment system that uses a plurality of modules to implement an efficient, scalable, and cost effective fluid treatment process to remove contaminants from a fluid. The multi-stage photo-catalytic oxidation fluid treatment system relies on mechanical and electronic elements, instead of chemicals, to treat the fluid that is input to the system and provide enhanced treatment of the contaminated fluid. The use of ozone and ions causes reactions with the contaminants that are contained in the fluid to purge the contaminants from the fluid or convert the contaminants to a form where they can be removed from the fluid or are rendered harmless.

The multi-stage photo-catalytic oxidation fluid treatment system is disclosed herein in the form of a water treatment system that can include a plurality of modules, including mechanical filtration, magnetic filtration, enhanced electro-coagulation, and an Ultra-Violet (UV) system. The magnetic filtration system is able to remove particles down to one micron or less to remove all flocculated particles, insuring the highest quality in waterturbidity and taste. The enhanced electro-coagulation system is a non-chemical process that removes iron, arsenic, manganese and oils. Significant disinfection and the removal of water hardness are also accomplished in the process. The UV system includes an ozone system that removes deadly viruses, bacteria, pesticides and other organic contaminates. Ozone, unlike chlorine leaves no harmful residuals within the drinking water.

### BRIEF DESCRIPTION OF THE DRAWINGS

FIGS. 1-3 illustrate, in top plan, front (section B) and rear (section A) cross-section views, respectively, the overall architecture of the present multi-stage photo-catalytic oxidation fluid treatment system in the form of an embodiment that is used to treat contaminated water;

FIG. 4 illustrates a perspective view of the electro-coagulator system;

FIG. 5 illustrates a perspective view of the reaction chamber of the electro-coagulator system;

FIG. 6 illustrates, in exploded perspective view, additional details of the enhanced electro-coagulator system; and

FIG. 7 illustrates a perspective exploded view of the electrical interconnection of the plates of the reaction chamber with external power wiring.

### DETAILED DESCRIPTION OF THE DRAWINGS

The present multi-stage photo-catalytic oxidation fluid treatment system uses a plurality of modules to implement an efficient, scalable and cost effective fluid treatment process to remove contaminants from a fluid. The multi-stage photo-catalytic oxidation fluid treatment system relies on mechanical and electronic elements, instead of chemicals, to treat the fluid that is input to the system and provide enhanced treatment of the contaminated fluid. The use of ozone and ions causes reactions with the contaminants that are -contained in the fluid to purge the contaminants from the fluid or convert the contaminants to a form where they can be removed from the fluid or are rendered harmless.

Water Treatment System Architecture

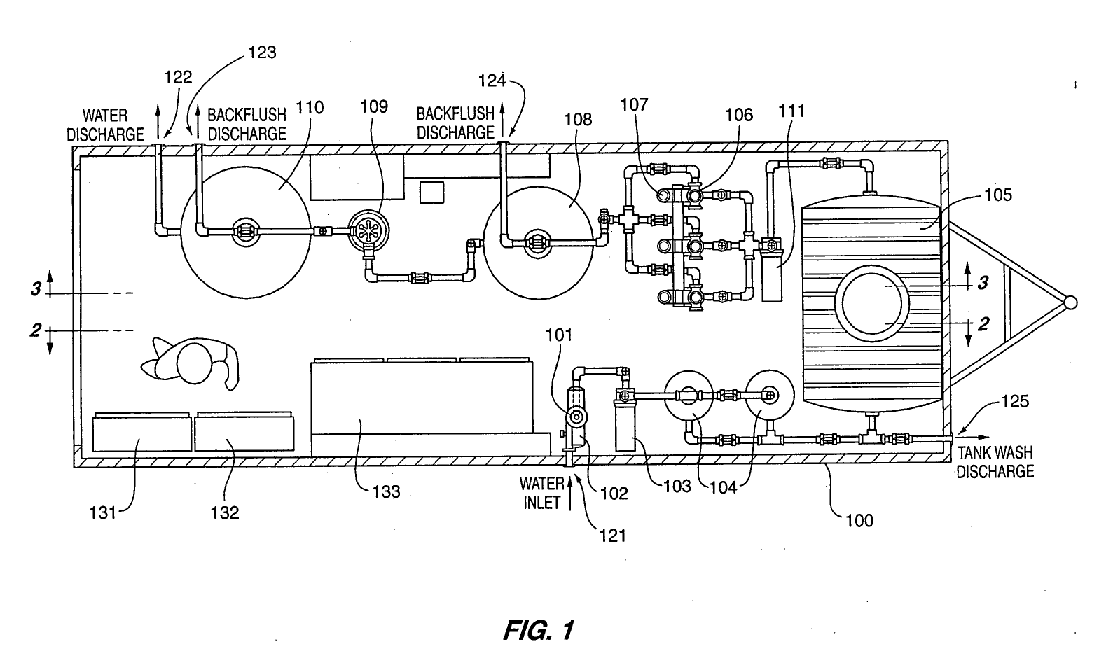

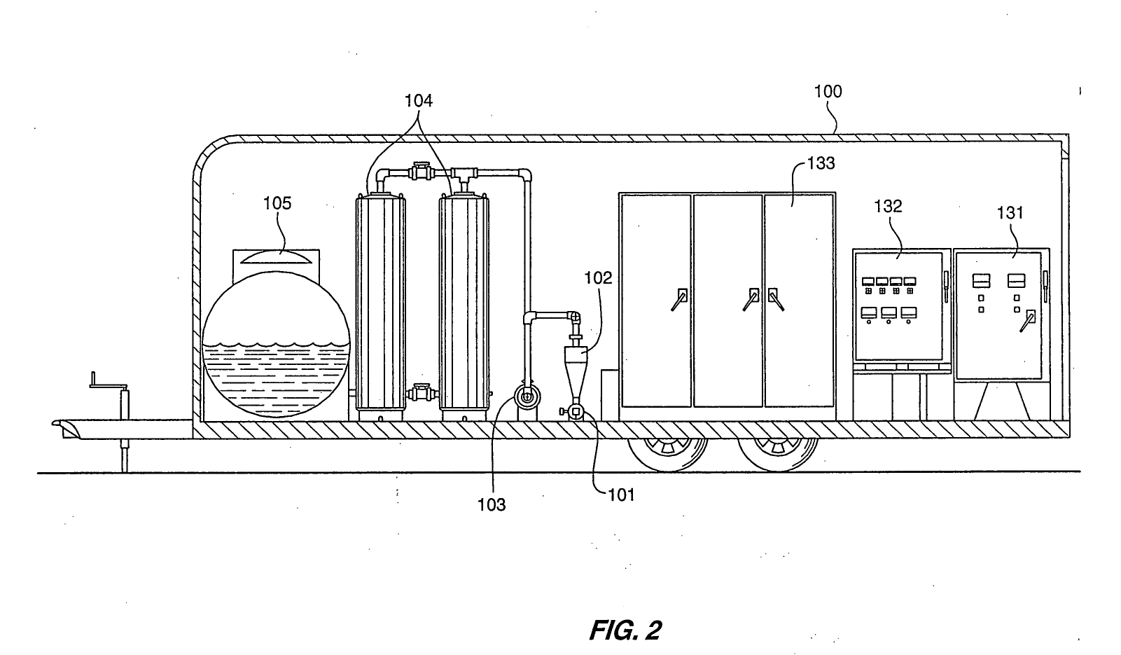

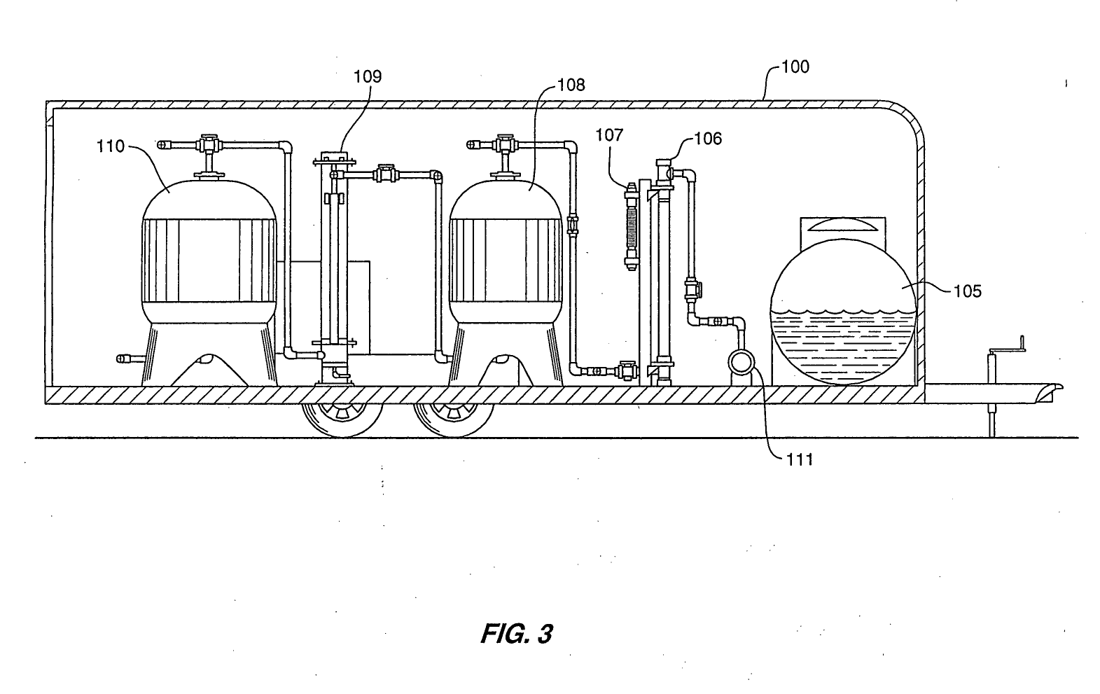

FIGS. 1-3 illustrate, in top plan, front and rear cross-section views, respectively, the overall architecture of the present multi-stage photo-catalytic oxidation fluid treatment system in the form of an embodiment that is used to treat contaminated water. This system description is intended to illustrate the operation of the present multi-stage photo-catalytic oxidation fluid treatment system and is not intended to limit the scope of the application of the concepts taught herein, as articulated in the appended claims.

The multi-stage photo-catalytic oxidation fluid treatment system (termed “water treatment system” herein) can include a plurality of modules, including mechanical filtration, magnetic filtration, enhanced electro-coagulation, and an Ultra-Violet (UV) system. The magnetic filtration system is able to remove particles down to one micron or less to remove all flocculated particles, insuring the highest quality in water turbidity and taste. The enhanced electro coagulation system is a non-chemical process that removes iron, arsenic, manganese and oils. Significant disinfection and the removal of water hardness is also accomplished in the process. The UV system includes an ozone system that removes deadly viruses, bacteria, pesticides and other organic contaminates. Ozone, unlike chlorine leaves no harmful residuals within the drinking water.

The water treatment system is shown in an implementation where the apparatus is installed within a standard sized trailer 100. This enables the water treatment system to be transported to the site where it is to be used. This system is scalable and can be reduced in size to serve a small location or increased in size to serve a large population. For convenience of description, the present embodiment is used to illustrate the concepts of the water treatment system. The water treatment system is connected to a source of contaminated water that is to be treated and is also connect to a discharge line to output the treated water. The contaminated water can contain various contaminants, and the filtration and treatment subsystems disclosed herein can be adjusted to address the particular contaminants at the installation site. Typical water sources are wells, stream flow, ponds/lakes, existing but malfunctioning municipal water systems, irrigation systems, and the like.

A typical system installation makes use of an input line that is served by one of the water sources noted above, which input line is connected to water inlet 121. The water treatment system connects the water inlet 121 to a feed pump 101 that is equipped with both a coarse strainer 102 that is used for the removal of gross solids, and an associated centrifugal sediment cleaner 103 designed to remove fine sand and grit. This apparatus serves to generate a flow of the contaminated water from the input line into the water treatment system and also mechanically removes the gross particulate contamination from the water received from this source. Once the particulate matter has been removed from the contaminated water, the inlet flow is passed through an ozone injector 104 and discharged into a water holding tank 105. The water holding tank 105 is used to provide a source of partially treated water for the remainder of the apparatus of the water treatment system and to enable the ozone to react with the contaminants in the water while the water is held in the water storage tank 105.

Ozone—The Universal Disinfectant

Ozone is injected into the water flow as noted above in order to treat this water to remove organic and inorganic contamination. When ozone comes into contact with organic contaminants, such as: bacteria, viruses, fungus and molds, it gives up an atom of oxygen (a free radical). This free radical oxidizes (destroys) the organic contaminants. These organic contaminants are life forms that are “anaerobic” in that they cannot live in the presence of activated oxygen. Disinfection by 3-atomic oxygen (ozone) takes place by rupture of the cell wall—a more efficient method than the use of chlorine that depends upon diffusion into the cell protoplasm and inactivation of the enzymes. An ozone level of 0.4 ppm for 4 minutes has been shown to kill any bacteria, virus, mold and fungus. In the area of viruses there is yet to be discovered an antibiotic that is truly effective. There are indications that DNA viruses such as Herpes are implicated in human cancers, since they organize the genetic material of the host cell to produce new viruses. Ozone inactivates viruses on contact even at very low residual concentrations. Mold and mildew are easily controlled by ozone in air and in water. Giardia and Cryptosporidium cysts are susceptible to ozone but not effected by normal levels of Chlorine.

Removal Of Heavy Metals

Ozone also operates on inorganic contaminants. For example, ozone oxidizes the transition metals to their higher oxidation state in which they usually form less soluble oxides, easy to separate by filtration, e.g. iron is usually in the ferrous state when it is dissolved in water. When iron in the ferrous state reacts with ozone, it yields ferric iron, further oxidized in water to ferric hydroxide that is very insoluble and precipitates out for filtration. Other metals, such as: arsenic (in the presence of iron), cadmium, chromium, cobalt, copper, lead, manganese, nickel, zinc—can be treated in a similar way.

Color Removal

Surface waters are generally colored by natural organic materials such as humic, fulvic and tannic acids. These compounds result from the decay of vegetative materials and are generally related to condensation products of phenol-like compounds; they have conjugated carbon/carbon double bonds. When the series of conjugated carbon/carbon double bonds extend upwards of twenty, the color absorption of these materials shows up in the visible spectrum. Ozone is attracted to humic, fulvic and tannic acids and functions to break organic double bonds. As more of these double bonds are eliminated by the action of the ozone on the humic, fulvic and tannic acids, the color disappears. Surface water can usually be decolorized when treated with 2 to 4 ppm of ozone.

Ozone vs. Chlorine

In comparing disinfection efficiency, ozone is effective 25 times more than hypochlorous acid (HOCl), 2,500 times more than hypochlorite (OCl) and 5,000 times more than chloramine (NH2CL). This is measured by comparison of CT constants—the concentration & time needed to kill 99.9% of all microorganisms. Chlorine reacts with organic materials to form chlorine-containing organics such as chloroform, carbon tetrachloride, chloromethane and others, generally known as trihalomethanes (THMs). In contrast, ozone reacts with organics to break them down into simpler compounds. These simpler compounds (e.g. oxalic acid) do not readily break down all the way to carbon dioxide with just ozone, but if subjected to bacterial degradation on activated charcoal, they are removed. This water can be later treated with a low level of chlorine say 0.2-0.3 ppm to maintain sanitation in the distribution system. In this way, no THMs are formed. The THMs have been implicated as carcinogens in the development of kidney, bladder and colon cancer. Ozone does not react significantly with THMs as they are more resistant to oxidation—it takes a very long time to achieve full oxidation. Some THMs are removed as a result of physical sparging by the aeration action of the ozone/air mixture.

Algae Removal

Ozonation of a water source that is contaminated with algae causes the algae to oxidize and float to the top of the reservoir. The ozone also oxidizes the metabolic by-products of the algae and removes the undesirable odor and taste.

Improved Coagulation & Turbidity Removal

Oxidation of dissolved organic materials by ozone results in polar and charged molecules that can react with polyvalent aluminum or calcium to form precipitates. Treatment of a surface water with up to 0.5 ppm of ozone results in a decrease in turbidity, improved settleability and a reduction in the number of particles. Referred to as pre-ozonation, this treatment destabilizes the colloid with a resultant reduction of the amount of coagulant needed to produce a clear filtrate.

Ozone Solubility

The solubility of ozone depends on the temperature of water and concentration of ozone in the gas phase. If oxidizable chemicals are present in the water, even more ozone dissolves to satisfy the demand. One limited factor is the efficient of the mass transfer device used. In case of a pump and bubble diffuser, the water column should be at least 16 ft. high. Higher concentrations of ozone in water cause more vigorous oxidation of even resistant organic compounds.

Enhanced Electro-Coagulation System

Once the contaminated water has been drawn into the water treatment system, mechanically filtered, saturated with ozone, and stored in water storage tank 105, a pump 111 draws a flow of water from the water holding tank 105 and discharges the water into an electro-coagulation system 106, that consists of at least one electro-coagulation module 401 as described herein.

Coagulation is one of the most important physicochemical operations used in water treatment. This is a process used to cause the destabilization and aggregation of smaller particles into larger particles. Water contaminants such as ions (heavy metals) and colloids (organics and inorganics) are primarily held in solution by electrical charges. Colloidal systems are destabilized by the addition of ions having a charge opposite to that of the colloid. The colloids, suspensions or emulsions thus destabilized separate by precipitation, filtration, and/or flotation.

Coagulation can be achieved by chemical or electrical means. Chemical coagulation is becoming less acceptable today because of the higher costs associated with chemical treatments; e.g. the large volumes of sludge generated, and the hazardous waste categorization of metal hydroxides, to say nothing of the costs of the chemicals required to effect coagulation. Electro-coagulation is an electrochemical process that concurrently removes heavy metals, suspended solids, emulsified organics and many other contaminants from water using electricity and sacrificial ions instead of expensive chemical reagents. The process utilizes direct current to cause release of sacrificial electrode ions to effect charge neutralization. The sacrificial electrode geometry may include plates, balls, fluidized bed spheres, wire mesh, rods, and tubes.

The water treatment system uses pump 111 to pass contaminated water into the electro-coagulation module 401 where it passes in a thin layer between metal plates charged with a direct electrical current (as described below). The plate material is discharged into the aqueous stream where ionic and non-ionic contaminants are subjected to the electrical charge, electrolysis products, and the plate elements. The applied electrical charge becomes a “driving element” to the chemical stabilization process. The electro-coagulation process produces a number of effects depending on the species of contaminant that is present, but generally contaminants are reacted to their most stable state and then are removed from the water by physical means.

The electro-coagulation process is based on scientific principles involving responses of water contaminants to strong electric fields and electrically induced oxidation and reduction reactions. Through application of electro-coagulation technology, over 99 percent of most heavy metal cations are removed. Other contaminants such as oil, silica or clay can be caused to simultaneously separate from colloids, suspensions or emulsions by neutralization of electrical charges through application of electro-coagulation technology. An added benefit of the electro-coagulation technology is the fact that process has also been shown to destroy viruses, bacteria and single-celled parasites and oocysts by electrically rupturing cellular membranes and scrambling the DNA.

Electro-Coagulation System

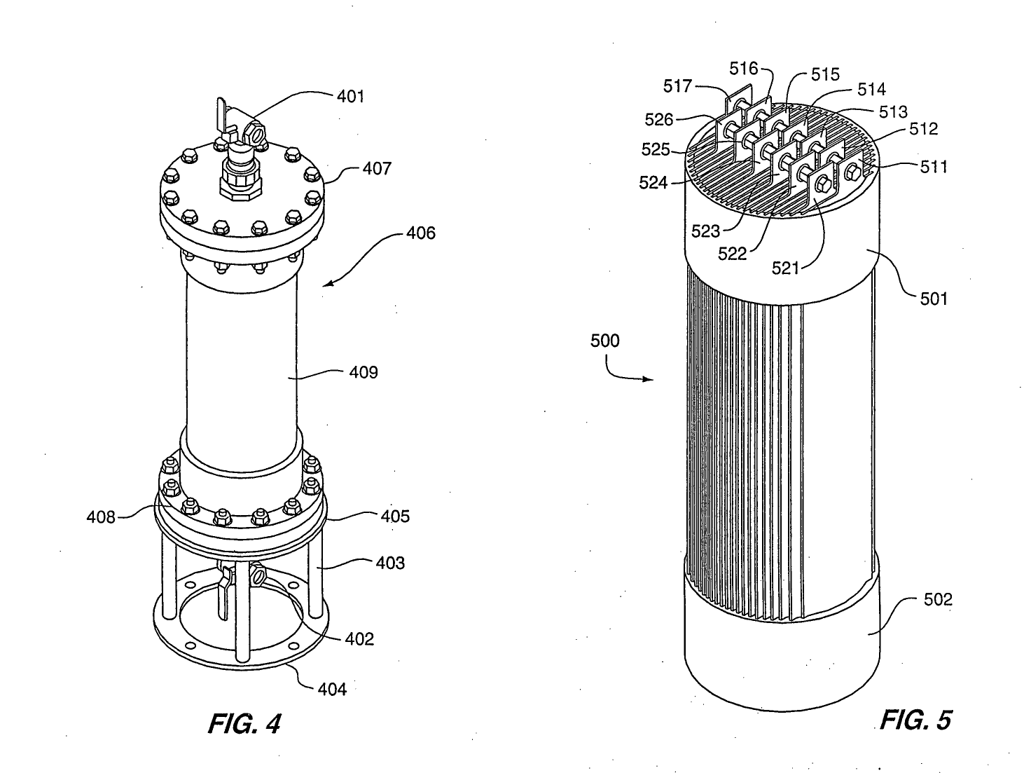

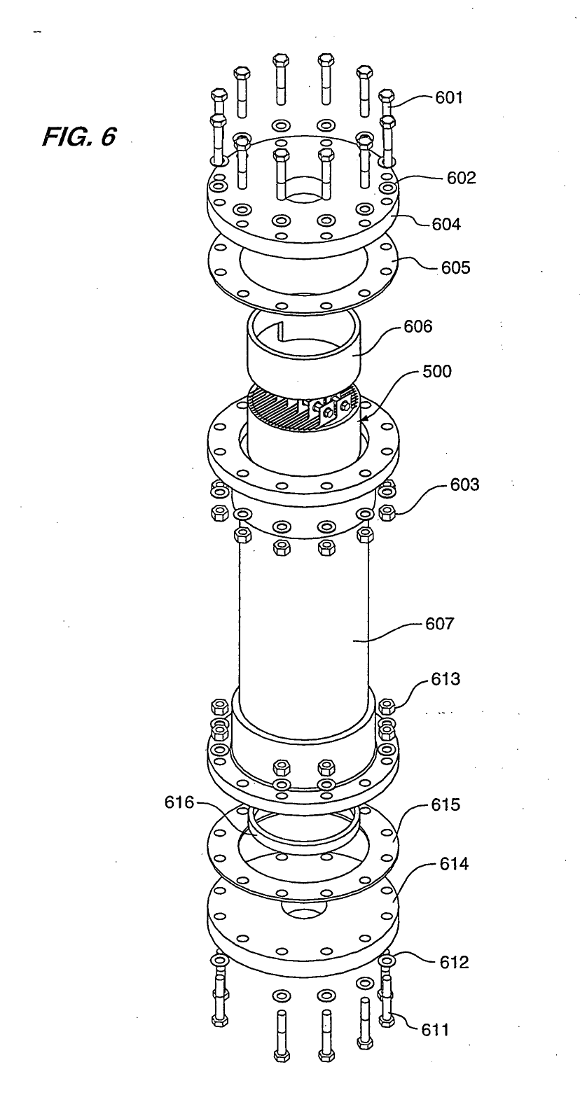

FIG. 4 illustrates a perspective view of an electro-coagulator module 406 of the electro-coagulator system 106, and FIG. 6 illustrates, in exploded perspective view, additional details of the electro-coagulator module 406. As shown in these figures, the electro-coagulator module 406 consists of a top flange assembly 407 and a bottom flange assembly 408 that are connected to electro-coagulator module body 409. The top flange assembly 407 and bottom flange assembly 408 are equipped with fluid ports/valves 401, 402, respectively, to carry the water into and out of the interior of electro-coagulator module body 409. A stand-off is also shown, consisting of plates 404, 405, that are interconnected by a plurality of spacers 403, to thereby support electro-coagulator module 406 when it is placed on a flat surface and to provide access to fluid port/valve 402.

As shown in FIG. 6, the top flange assembly 407 consists of flange plate 604, gasket 605 that are affixed to the top of the integral flange of electro-coagulator module body 607 by a plurality of bolts 601, washers 602 and nuts 603. Similarly, the bottom flange assembly 408 consists of flange plate 614, gasket 615 that are affixed to the top of the integral flange of electro-coagulator module body 607 by a plurality of bolts 611, washers 612 and nuts 613. The reaction chamber 500 is inserted in the electro-coagulator module body 607 and spacers 606, 616 used to position the reaction chamber 500 in the electro-coagulator module body 607.

Reaction Chamber

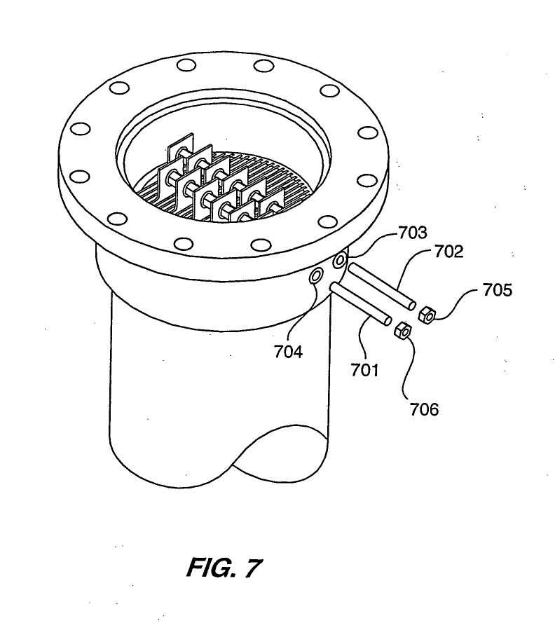

FIG. 5 illustrates a perspective view of the reaction chamber of the electro-coagulator system. The reaction chamber is the heart of the electro-coagulation module 406. The reaction chamber 406 produces an electrochemical reaction that allows organic and inorganic contaminants to precipitate as solids that can be removed through simple filtration, sedimentation, inclined plate clarification, dissolved air flotation, centrifuge, ultra filtration, or other approved industry separation devices. The electro-coagulation reaction chamber 406 is designed to process water or wastewater on a continuous-flow basis. The reaction chamber 406 consists of a number of metal electrodes (plates) 511-517, 521-526, such as either iron or aluminum plates, that are spaced appropriately within an electrically insulated, chemically resistant CPVC housing 501, 502. The housing 501, 502 may be equipped with a plurality of parallel oriented spaced apart slots, each of which serves to accept a corresponding one of the plurality of metal electrodes 511-517, 521-526. The two sets of metal electrodes 511-517, and 521-526 are each interconnected via a conductor, such as a threaded metal rod. Direct Current (DC) is applied to the electrodes 511-517, 521-526 within the electro-coagulation reaction chamber 406. The metal electrodes 511-517, 521-526 react to the DC current by releasing charged metal ions into the fluid. The flooding of electrons into the fluid neutralizes charged particles, allowing them to increase in size and to be removed through simple clarification. An average of 2 to 5 kilowatts is used per 1,000 gallons of typical water treated. The reaction chamber 406 includes a polarity reversal system to extend electrode life and prevent contaminants from coating the plates 511-517, 521-526. Each reaction chamber 406 is fitted with an individual ionized gas generator 107 to accelerate the electro-coagulation reaction. The ionized gas is aspirated directly into the reaction chamber 406 via an eductor. FIG. 7 illustrates the electrical connection of the plates of the reaction chamber 406 with external wiring to provide the required DC power to the electro-coagulation module 406. This is accomplished by the use of a pair of threaded metal rods 701, 702 that connect the two sets of metal plates 511-517, and 521-526 to corresponding positive and negative polarity sources of DC voltage.

Maintenance and Electrode Replacement

Maintenance requirements for the electro-coagulation system is minimal. The electro-coagulation system automatically shuts down if there is no fluid present and can be set up to automatically turn-on and process, based on the water treatment system demands. The sacrificial metal plates or electrodes require periodic replacement. Metal plates are 0.125/0.145 inches thick (aluminum and iron respectively) and are readily removed as a “cartridge pack”. To effect the conversion of the iron and manganese ionic metal contaminants to settleable metal oxides the metal electrodes must be sacrificial and release 0.05-0.20 pounds of metal per each 1,000 gallons of treated water, the amount sacrificed varies with the actual chemistry of the water to be treated. Electrode replacement consists of simply removing the flanged ends of each reaction chamber, sliding the “cartridge pack” of electrodes out of the electro-coagulation chamber, and sliding the new electrode pack into place. Electrode replacement may be performed readily by one individual.

Electrolytic Filtration

The treated water that flows out of the electro-coagulation system is input into electromagnetically enhanced pressure filter 108. In the electromagnetically enhanced pressure filter 108, the filtration media, the solid contaminants and the passing water stream are magnetically activated. Filtration capability and capacity are determined by the magnetic field strength, the porosity of the media, and the overall wastewater chemistry and kinetics. The electromagnetically polarized filtration media enhances the removal of contaminants by bridging particles with paramagnetic oxygen and nitrogen molecules from other upstream water treatment processes. The phenomena of bridging and nucleating attaches a magnetic “handle” on the contaminants. These contaminants are “grabbed” by the charged media. The three-dimensional filtration profile of the electromagnetically enhanced pressure filter 108 and the magnetic “tagging” results in superior filtration performance . . . higher loading rates and the removal of smaller particle sizes. The electromagnetically enhanced pressure filter 108 automatically back flushes on a periodic basis, however this back flush rate depends on the total amount of contaminants being handled by the water treatment system. The electromagnetically enhanced pressure filter 108, is able to remove particles down to one micron or less. Removing all flocculated particles, insuring the highest quality in water turbidity and taste.

UV Treatment

Fresh water is one of our most valuable natural resources, but it is extremely difficult to know whether our water is contaminated. This is because microorganisms naturally exist on all surfaces exposed to air, including water. Many of these microbes have the potential to cause disease. The term for these disease-carrying microbes is pathogens. In order to destroy harmful pathogens, water must be disinfected. One process that aids in disinfection is Ultra-Violet (UV) treatment. UV treatment is a highly effective and acceptable means of disinfecting water to meet the microbiological requirements of the Public Health Service Drinking Water Standards.

Water enters the purifier's 109 chamber. Once inside, it is exposed to UV light. The UV lamp used for this type of germicidal disinfection produces light at a predetermined wavelength (such as a typical value of 253.7 nanometers or 2,537 Angstrom units). At this wavelength, UV light destroys up to 99.9% of all bacteria, protozoa, viruses, molds, algae and other microbes. This includes such waterborne diseases as: E. coli, hepatitis, cholera, dysentery, typhoid fever as well as many others. The actual UV lamp(s) is housed in a quartz sleeve. This sleeve not only helps maintain maximum operating temperature, but also prevents the UV lamp form coming in contact with the water. While in the chamber, the water receives doses of UV energy. To be effective, a minimum dosage of 50,000 microwaft second per square centimeter is applied. Since the treatment does not change either physical or chemical properties, the water is ready for use when it leaves the purifying unit 109.

There are many advantages to this type of treatment: no need for toxic and expensive chemicals, fast treatment, low maintenance, simple handling and extremely low cost operation. This proven technology is not only extremely reliable, but is scalable to treat millions of gallons per day. Once installed, the units only need periodic cleaning and annual lamp replacement.

Carbon Filter

The final stage of treatment is the use of a carbon filter 110 to remove any taste. Most tastes and odors in water supplies come from naturally occurring or manmade organic material contamination. Bacterial decomposition of humic material imparts taste to surface water, also the action of algae and actinomycetes give rise to objectionable tastes. Chlorination of humic material leads to chlorophenols that are far stronger odor and taste antagonists than the original phenol and the chlorine. Most of these odors are removed by treatment with ozone. Even some sulfur compounds such as hydrogen sulfide, mercaptans ororganic sulfides can be oxidized to sulfates with ozone. As noted above, ozone reacts with organics to break them down into simpler compounds. These simpler compounds (e.g. oxalic acid) do not readily break down all the way to carbon dioxide with just ozone, but if subjected to bacterial degradation on activated charcoal, they are removed.

Water Treatment System Controls

The water treatment system makes use of electrical and mechanical processes to treat contaminated water. There are a number of power source and control systems that are required to operate the water treatment system. As shown in FIGS. 1-3, a control panel 131 is provided to regulate the operation of the water treatment system. The control panel provides an operator with the meters, controls, switches, and the like that measure the system performance and enable the system operator to control the water flow rate, water pressure and the like. There is also provided a power supply 132 for the electro-coagulator units and a power supply 133 for the enhanced ozone generator units.

The controls used in the system include maintenance controls to activate, on a periodic basis as noted above, backflow or backflush operations, which flush the various system components and discharge through discharge ports 123-125.

Summary

The multi-stage photo-catalytic oxidation fluid treatment system relies on mechanical and electronic elements, instead of chemicals, to treat the fluid that is input to the system and provide enhanced treatment of the contaminated fluid. The use of ozone and ions causes reactions with the contaminants that are contained in the fluid to purge the contaminants from the fluid or convert the contaminants to a form where they can be removed from the fluid or are rendered harmless.

1-5. (Canceled)

6. A method of operating a fluid treatment system for removing contaminants from a fluid, where said fluid comprises at least one component and at least one contaminant, said at least one contaminant being a one of the set of forms of contaminant comprising: solution, suspension, mixture, the method of operating a fluid treatment system comprising the steps of:
treating said contaminated fluid using a decontamination process selected from the class of decontamination processes comprising: mechanical, electrical, magnetic, photo-optical; and
electro-coagulating said contaminated fluid in an electro-coagulator; and
wherein said step of treating and said step of electro-coagulating are performed seriatim to treat said contaminated fluid to remove said at least one contaminant from said at least one component.

7. The method of operating a fluid treatment system of claim 6 wherein said step of treating comprises:
mechanically filtering, in response to receipt of an input flow of contaminated fluid, said contaminated fluid to remove particulates from said contaminated fluid.

8. The method of operating a fluid treatment system of claim 7 wherein said step of treating further comprises:
injecting ozone into said filtered contaminated fluid;
storing said ozonated filtered contaminated fluid in a fluid storage tank; and
generating a flow of said ozonated filtered contaminated fluid from said fluid storage tank to said electro-coagulator.

9. The method of operating a fluid treatment system of claim 6 wherein said step of treating comprises:
injecting ozone into a fluid processed by said electro-coagulator; and
magnetically filtering said ozonated fluid process by said electro-coagulator.

10. The method of operating a fluid treatment system of claim 6 wherein said step of treating comprises:
passing said magnetically filtered fluid through a carbon filter to produce an output flow of said at least one component.

11-14. (Canceled)

15. A method of operating a fluid treatment system for removing contaminants from a fluid, where said fluid comprises at least one component and at least one contaminant being a one of the set of forms of contaminant comprising: solution, suspension, mixture, the fluid treatment system comprising a plurality of treatment elements, each having an inlet and an outlet, fluid flow path connected to and serially interconnecting said plurality of treatment elements by joining an inlet on a treatment element with an outlet of a previous treatment element in said series, said method comprising a plurality of treatments comprising the steps of:
mechanically filtering, in response to receipt of an input low of contaminated fluid, said contaminated fluid to remove particulates from said contaminated fluid;
injecting ozone into said filtered contaminated fluid;
electro-coagulating said ozonated filtered contaminated fluid in an electro-coagulator;
injecting ozone into a fluid processed by said electro-coagulator;
magnetically filtering said ozonated fluid processed by said electro-coagulator; and
passing said magnetically filtered fluid through a carbon filter to produce an output flow of said at least one component.

16. The method of operating a fluid treatment system of claim 15 further comprising the step of:
storing said ozonated filtered contaminated fluid in a fluid storage tank for use by said electro-coagulator.

17. The method of operating a fluid treatment system of claim 16 further comprising:
generating a flow of said ozonated filtered contaminated fluid from said fluid storage tank to said electro-coagulator.

18. The method of operating a fluid treatment system of claim 15 further comprising the step of:
generating said input flow of said contaminated fluid from a fluid inlet to said mechanical filter.
